(19) United States
(12) Patent Application Publication
(10) Pub. No.: US 2007/0215735 A1
(43) Pub. Date: Sep. 20, 2007

(54) Food processor drive assembly

(76) Inventor: Theodore B. Mulle, New Milford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/377,028

(22) Filed: Mar. 16, 2006

(51) Int. Cl. A47J 43/046

(52) U.S. Cl. 241/282.1

(57) ABSTRACT

A dedicated, sealed driven shaft assembly (28, 30) is mounted in a sealing manner to the floor (24) of a food processor bowl (14). The driven shaft (30) is adapted on one end to engage the motor drive shaft (20) when the bowl is mounted on the base (12). The other end of the driven shaft (30) is adapted to receive one of a plurality of blades (36) and specialized blade attachments.

### CROSS-REFERENCE TO RELATED APPLICATIONS

None.

### TECHNICAL FIELD

The present invention relates to food appliances and, more particularly, to food processors of the type having a bowl and a rotating blade wherein food product is delivered into the bowl in contact with the blade.

### BACKGROUND OF THE INVENTION

Known food processors consisting of an electrically driven rotating blade positioned near the bottom of a food bowl typically comprise a single, vertically aligned rotating driven shaft for driving the blade. The bowl is mounted on top of the base which contains the motor and drive assembly. The shaft usually protrudes up from the base and the bowl has an opening in the center of the floor that fits over the shaft. The blade is attached after then bowl is placed over the shaft. The blade typically has a splined or non-round hub that slides on top of a correspondingly shaped drive shaft surface to impart torque to the blade. Because the blade hub simply rests on the drive shaft in a sliding fit, and because of friction concerns and for economic reasons no seal is provided between the moving blade hub and the stationary bowl, the bowl cannot hold a liquid or food product with liquid consistency of a height that will reach above the edge of the blade shaft opening in the bowl. In addition, the known designs are subject to leakage at the shaft opening of the bowl and, when disassembling for cleaning, the blade and hub must be manually removed while covered with food product.

Known beverage blenders have blending jars that are mounted on a drive shaft on a base, in which the blade is mounted to a drive system that is attached firmly to the jar and forms the floor of the jar in a sealed manner so that liquid can be contained and transported therein. In contrast to known food processors, the blade can be fixed to the blender jar. In food processors, it is desirable to be able to easily and conveniently lift the blade off of the shaft and out of the bowl, and to install it with the same ease and convenience for reasons including the ability to select from a group of blades or specialized blade attachments.

To construct a food processor drive assembly like that of a beverage blender would require either limiting the appliance to a single blade to forego the associated high expense of providing several, or providing multiple self-contained blade assemblies of the type used for beverage blenders and, thus, requiring a high expense.

### OBJECTS OF THE INVENTION

It is an object of the present invention to provide a versatile food processor drive assembly that overcomes the shortcomings of known designs, that provides the benefits of a self-contained assembly such as that use in known beverage blenders, and that provides a versatile set of blades and specialized blade attachments.

These objects, as well as others, are achieved by the present invention.

### BRIEF SUMMARY OF THE INVENTION

The present invention achieves the above-mentioned objects by utilizing a dedicated, sealed driven shaft assembly that is mounted in a sealing manner to the floor of a food processor bowl. The driven shaft is adapted on one end to engage the motor drive shaft when the bowl is mounted on the base. The other end of the driven shaft is adapted to receive one of a plurality of blades and specialized blade attachments.

### BRIEF DESCRIPTION OF THE DRAWINGS

FIG. 1 is a schematic, cross-sectional view of a food processor according to the present invention.

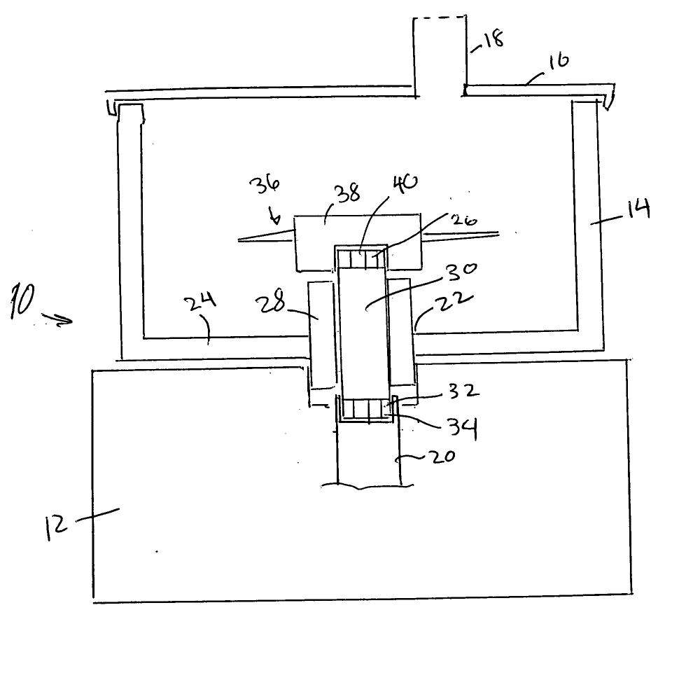

### DESCRIPTION OF THE PREFERRED EMBODIMENTS

A food processor (10) according to the present invention comprises a base (12), a bowl (14), a lid (16), and a food product delivery chute (18). A conventional electric motor (not shown) and associated drive assembly (not shown) of the type generally known are located in the base (12). A drive shaft (20) extends up and out of the base (12) and is non-round shaped in order to transmit torque. The bowl (14) has an opening (22) in the floor (24). A bearing assembly (28) is positioned in the opening (22). Any bearing assembly of a type conventionally known may be used. The bearing assembly (28) mounts inside of the opening (22) in a sealing manner and it rotatably supports a driven shaft (30). The driven shaft (30) is thus rotatably fixed to the bowl within the bearing assembly (28). The sealed assembly (28) allows liquids and liquid-consistency food products to be held in the bowl (14) at any depth the bowl can accommodate. Leaking is prevented by the sealed bearing assembly (28).

The driven shaft (30) has on its lower end (32) a drive coupling configuration (34) of a conventional type to engage the drive shaft (20) for torque transmission therewith. When the bowl (14) is placed on the base (12), the coupling configuration (34) is placed on the drive shaft (20).

The upper end (26) of the driven shaft (30) has a blade receiving configuration (40) to receive a blade (36) or a specialized blade attachment. The blade (36) has a hub (38) with a conventional type coupling for transmission of torque. The upper end (34) of the driven shaft (30) has a corresponding configuration that engages for transmission of torque.

After the bowl (14) is positioned on the base (12) and the drive shaft (20) and driven shaft (30) are coupled, a user places a blade (36) on the upper end (34) of the driven shaft (30) by sliding it over the driven shaft (30). The user then positions the lid (16) on the bowl and delivers food product through the chute (18) into the bowl (12). The user may choose to put food product into the bowl before placing the lid (16) in position. The user then activates the motor causing the blade (36) to rotate and chop the food product.

While the preferred embodiments of the present invention have been herein described, various modifications may be made without departing from the scope of the present invention.

What is claimed is:

1. A food processor comprising
a base housing an electric motor and a drive shaft connected to said motor and adapted to be rotated;
a bowl for holding food product, said bowl having a floor and an opening in the floor;
a sealed bearing assembly fixed in the opening in a sealing manner with respect to said bowl;
a driven shaft rotatably fixed within said bearing assembly, said driven shaft having a first end adapted to engage said drive shaft in a manner such that torque is transmitted between said drive shaft and said driven shaft; and
a blade assembly adapted to be mounted to a second end of said driven shaft.

2. A food processor according to claim 1, further comprising
a lid for covering said bowl; and
a food product chute for delivering food product into said bowl.
